(19) United States
(12) Patent Application Publication
(10) Pub. No.: US 2020/0336884 A1
(43) Pub. Date: Oct. 22, 2020

(54) Mobile App

(71) Applicant: Help! Help!, LLC, Avon, IN (US)

(72) Inventors: Javier Casas, Avon, IN (US); Mark Albrechtsen, Plainfield, IN (US); Andrei Vasiliu, Chisinau (MD)

(21) Appl. No.: 16/756,603

(22) PCT Filed: Oct. 17, 2018
(86) PCT No.: PCT/US18/56247

§ 371 Date: Jun. 27, 2020

Related U.S. Application Data
(60) Provisional application No. 62/574,143, filed on Oct. 18, 2017.

(51) Int. Cl. H04W 4/90; H04W 4/021; H04W 4/14; G08B 25/10; G08B 3/10

(52) U.S. Cl. CPC H04W 4/90; H04W 4/022; G08B 3/10; G08B 25/10; H04W 4/14

(57) ABSTRACT

The present invention is a personal security mobile application that monitors the surrounding speech for specific ALERT triggers (e.g. if someone shouts “HELP HELP”). The ALERT triggers cause the application to send a SMS with an URL to user defined emergency numbers including local emergency number (9-1-1 for U.S.). The URL leads to a web page that provides real-time location data of the user as well as additional information provided by application on request or by default.

### CROSS REFERENCE TO RELATED APPLICATION

This application is a continuation (PCT Bypass) application of International Patent Application No. PCT/US2018/056247, filed on Oct. 17, 2018, which claims the benefit of U.S. Provisional Application No. 62/574,143, filed Oct. 18, 2017, the subject matter of which is expressly incorporated by reference.

### FIELD

The disclosure relates to a personal security mobile application.

### BACKGROUND

The Justice Department counted 5.0 million violent crimes involving over 2.7 million victims in 2015. It estimates there were over 284,910 firearm victims in 2015. Statistically 33% of women in the USA will be violently victimized at least once in their lifetimes.

According to criminal deterrence theory, an attack occurs after the criminal makes a cost-benefit analysis. The criminal will act if the benefit outweighs expected consequence. Criminals also know the chances that the police will be in earshot during an attack are low.

Calls to the police are not sufficient for deterrence. Statistics indicate law enforcement will typically not have enough time to respond before a criminal act occurs. More often than not, law enforcement's role is pursuit, investigation and witness for prosecution of the criminal act. The Federal Communications Commission estimated that about 70 percent of 911 calls are placed from cell phones and the number of 911 calls placed from cell phones is growing.

Two possible ways to determine location of a cell phone is satellite GPS and Apple's AGPS. The main difference between AGPS and GPS is that AGPS is faster. Satellite GPS signal can take up to a few minutes to get the location, whereas AGPS uses the signals and known position of cell towers and triangulates the device position according to the signal strength from the fixed positioned cell towers. AGPS produces a location is not as accurate as satellite GPS, but instead it is fast. The major mobile operating systems (iOS and Android) locate the position of the device—by initiating AGPS and GPS connection at the same time. The first arrived data is usually AGPS which is quick, but not necessarily accurate location. This data is provided to the application and then when more accurate GPS data arrives this also gets provided to the application. In this way the application gets relevant location data very quickly and this data gets more accurate in time. More info on AGPS can be found at www.diffen.com/difference/A-GPS_vs_GPS.

Every second matters when responding to an emergency situation, such as a medical emergency. When a 911 call is placed from a cell phone, the initial cell phone message is typically insufficient to provide location information to the 911 dispatcher. The FCC requires that all wireless carriers must be able to pinpoint the cell phone's location for 911 dispatchers but the procedures are not yet in place and there are exceptions like mobile satellite service providers. The time it takes to call 911, speak to a 911 dispatcher and accurately communicate the emergency along with an accurate description of the location of the emergency delays emergency response. Furthermore, the 911 dispatcher has to accurately relay information to emergency responders. There is a need to minimize the time needed for this process to allow for faster and more accurate response.

U.S. Patent Application Publication No. 20120329420A1 by Zotti et al., published Dec. 27, 2012, discloses a personal safety application for a mobile device and a method. The application includes voice-activated commands created by the subscriber and text messaging emergency first responders (see paragraphs [0019], [0027], [0037]. The service provider acts as the initial contact for the subscriber and the service provider reviews audio, video, or text messages sent from the subscriber or otherwise communicates with the subscriber to validate the crisis. If the crisis is valid, then the service provider contacts emergency authorities. The emergency authorities act as so-called “Tier 2 Support” to further assist the subscriber via an emergency (see paragraph [0016]). HTTP/HTTPs requests are communicated over TCP/IP networks (see paragraph [0055]) and real-time data is uploaded to the service provider server while alert signal is active (see paragraph [0015]), but the alert data is not continually uploaded to a website.

U.S. Patent Application Publication No. 2013/0337875 A1 by DiPerna et al., published Dec. 29, 2013, discloses an emergency personal protection system integrated with mobile devices. The system includes voice-activated commands and text messaging an emergency assistance number such as 911 (see paragraphs [0036], [0037], [0039]). Image data can be sent through a regular TCP/IP to a web service, which enables internet access on a cell phone (see paragraph [0036]). The system disclosed in DiPerna does not disclose uploading any data in real time.

U.S. Patent Application Publication No. 2009/0215424 A1 by Petite, published Aug. 27, 2009, discloses a system and method for transmitting an emergency message over an integrated wireless network. The emergency message system employs a transceiver network with a plurality transceivers coupled to monitoring devices residing at a plurality of customer premises. Control room operators receive an emergency message from an identifiable transceiver. The transceiver, identified by an identification code, indicates a location and the nature of the emergency condition so that the control operators may request appropriate emergency assistance. Petite teaches sending a text message to 911 dispatch, but does not disclose voice activation or an application for mobile device.

U.S. Patent Application Publication No. 2008/0227429 A1 by Hodgson et al., published Sep. 18, 2008, discloses a wireless communication device that is triggered by a user in a duress situation, and sends a message and other data to emergency response call center personnel. Hodgson teaches sending a text message to 911 operators, but does not disclose voice activation or an application for mobile device.

U.S. Patent Application Publication No. US 2016/0057600 A1 by Ung, published Feb. 25, 2016, discloses a wireless device that permits location information for wired devices in non-voice emergency communication to be disseminated only to 911 or E911 emergency services. Ung does not disclose voice activation or uploading data in real time.

### SUMMARY

The present invention is in the field of personal safety and more particularly a personal protective application for cellular devices connected to a network.

The present invention is a personal security mobile application that monitors the surrounding speech for specific ALERT triggers (e.g. if someone shouts “HELP HELP”). The ALERT triggers cause the application to send a message via short message service (SMS) with a web address (URL) to user defined emergency numbers including national emergency number (9-1-1 for U.S.). The URL leads to a web page that provides real-time location data of the user as well as additional information provided by application on request or by default.

The invention disclosed herein is a personal security mobile application that monitors the surrounding speech for specific ALERT triggers (e.g. if someone shouts “HELP! HELP!”). The ALERT triggers cause the application to send a SMS with an URL to user defined emergency numbers including emergency number (9-1-1 for U.S.). The URL leads to a web page that provides real-time location data of the phone and hopefully the phone's user as well as additional information provided by the application on request or by default.

In additional aspects of the invention, the application is open prior to switching to READY status session.

In additional aspects of the invention, the user must enable location and privacy before switching to READY status session.

In another aspect of the invention, the ALERT SESSION data is available for the duration of the active ALERT SESSION.

In additional aspects of the invention, the application sends SMS to emergency numbers. The application does NOT send SMS messages from user's mobile number because 3rd party apps are NOT allowed to send SMS messages without user's explicit action, like press of a confirmation button. The message includes an URL where ALERT session data is provided from user's device. The URL leads to a web application that has access to the same real-time database and data for the user's device.

In another aspect of the invention, the web application shows the geo-positional movement of user's device in real-time on a map.

In another aspect of the invention, the web application provides action buttons to initiate specific actions on user's device (e.g. start an alarm sound on user's device, instruct user's device to initiate audio and/or video call to a specific number with options to choose one-way audio and/or front/back camera, speaker volume, etc.).

In further aspects of the invention, the real-time database is a centralized data storage in the cloud which is accessible to multiple end-points (devices) simultaneously. Each end-point can read and write data in the database according to specific permission rules. When the data is modified, the changes are pushed to all end-points in real-time.

In additional aspects of the invention, after ALERT SESSION is canceled, the application returns to READY status session.

### BRIEF DESCRIPTION OF THE DRAWINGS

The above-mentioned and other features of this disclosure, and the manner of attaining them, will become more apparent and the disclosure itself will be better understood by reference to the following description of embodiments of the disclosure taken in conjunction with the accompanying drawings, wherein:

FIG. 1 illustrates the application flow chart leading to ALERT mode.

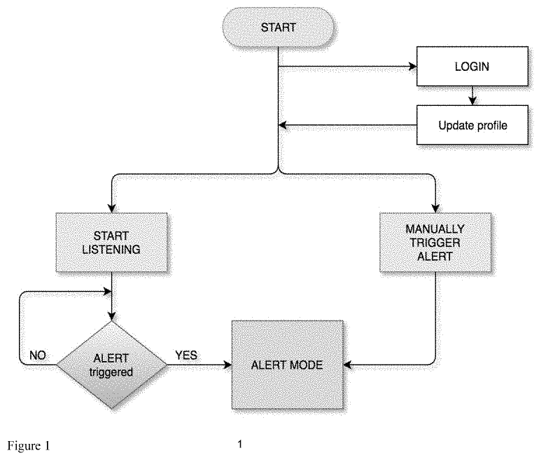

FIG. 2 illustrates the application flow chart following ALERT mode.

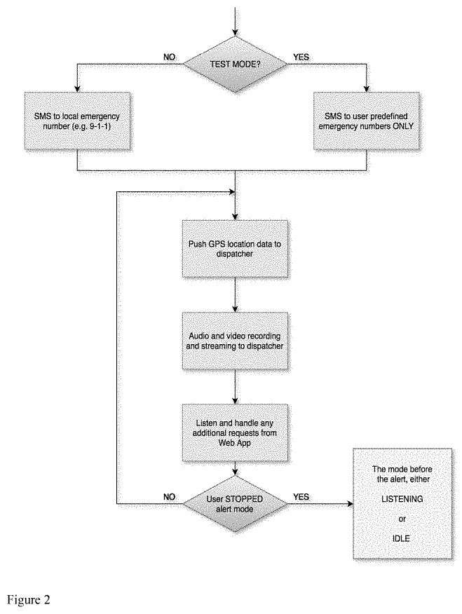

FIG. 3 illustrates the application login screen.

FIG. 4 illustrates the application main screen.

FIG. 5 illustrates the application user's profile screen.

FIG. 6 illustrates the application status screen.

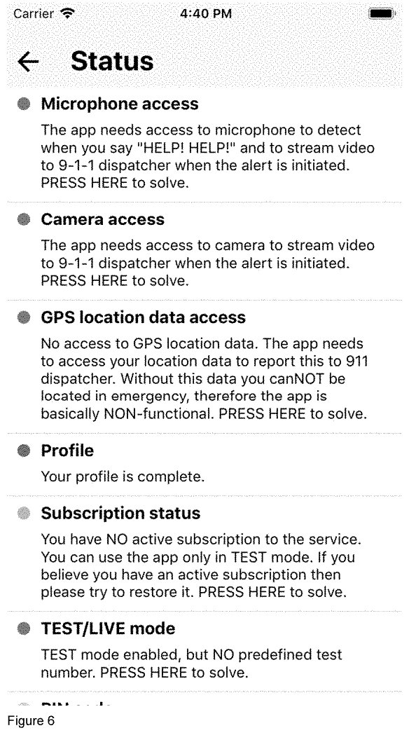

FIG. 7 illustrates the dispatcher's view of the URL screen.

FIG. 8 illustrates a dispatcher's view when the application is providing to the URL a view of the dispatcher's screen.

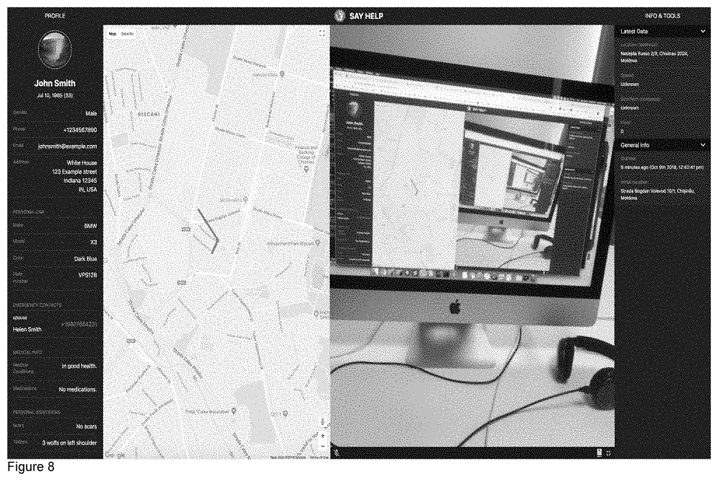

Corresponding reference characters indicate corresponding parts throughout the several views. Although the drawings represent embodiments of the present disclosure, the drawings are not necessarily to scale and certain features may be exaggerated in order to better illustrate and explain the present disclosure.

### DETAILED DESCRIPTION OF THE EXEMPLARY EMBODIMENTS

The embodiments disclosed below are not intended to be exhaustive or limit the disclosure to the precise forms disclosed in the following detailed description. Rather, the embodiments are chosen and described so that others skilled in the art may utilize their teachings.

The invention disclosed herein is a personal security mobile application that monitors the surrounding speech for specific ALERT triggers (e.g. if someone shouts “HELP HELP”). The ALERT triggers cause the application to send a SMS with an URL to user defined emergency numbers including national emergency number (9-1-1 for U.S.). The application continues to provide real-time location data to the web page. The URL leads to the web page that provides the real-time location data of the mobile phone as well as additional information provided by application on request or by default.

User's Experience

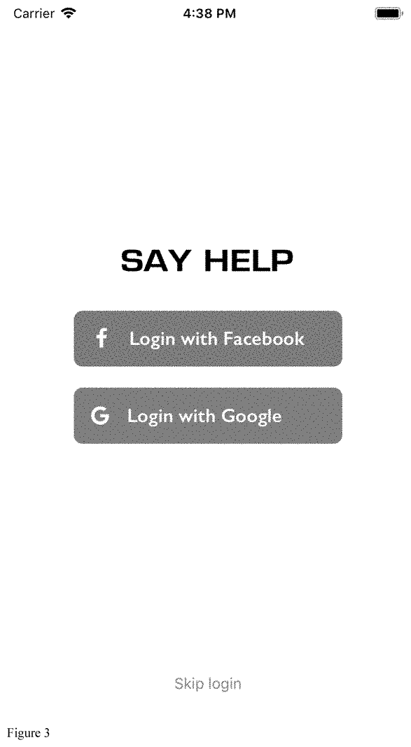

As illustrated in FIG. 3, the application starts on the login screen and the user has 3 options for the login: Facebook login, Google login, or Anonymous login (i.e., skip login).

Facebook and Google login make the application fully functional, but Anonymous login allows TEST mode ONLY. Anonymous login allows a user to test certain functionality of the app without an account. Anonymous login just skips the login process and takes the user to the main application screen. However an anonymous login is just for testing purposes. If the user is Anonymous then the application will not switch into a READY status session and the application will only send a dispatch to 911 in the READY status session.

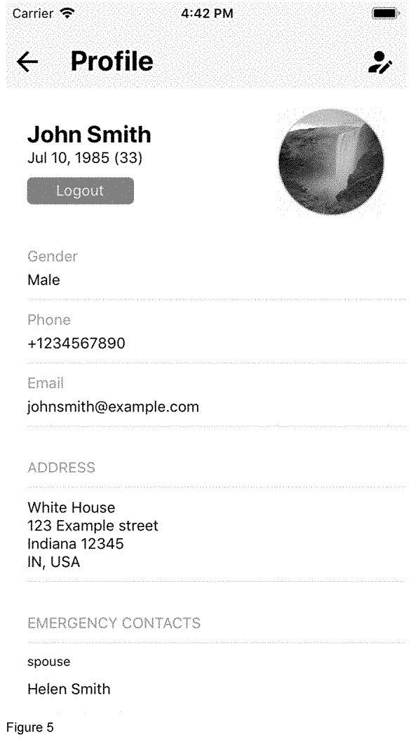

As illustrated in FIG. 5, the application allows the user to set personal emergency data. The personal emergency data of the user may include a picture of the user, name, date of birth+calculated age, gender, home, business, mobile or alternative phone number, email, home mailing address, next of kin or emergency contact including name, relationship, phone number, personal vehicle including the make, model, color, or plate number, medical information of the user including a list of conditions, notes, or medications, and personal physical identifiers such as scars or tattoos.

Application Status

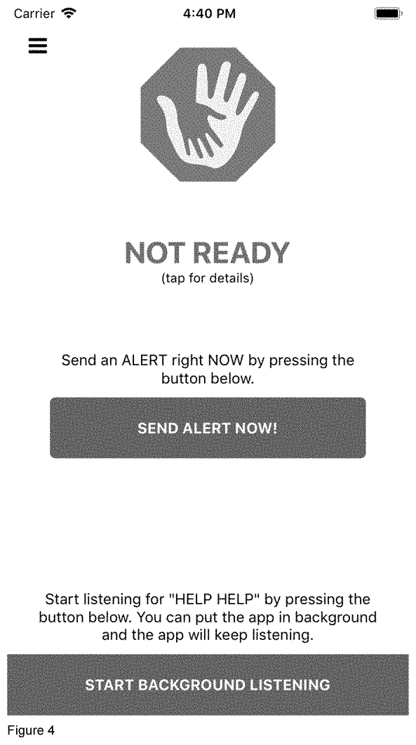

The application can be in any of the following status settings: NO INTERNET, NOT READY, TEST MODE, TEST MODE (MANUAL ALERT ONLY), MANUAL ALERT ONLY, or READY. As illustrated in FIG. 4, the application main screen displays the status setting of the application to make sure the status setting of the application is clear to the user.

No Internet

The application is NOT functional because there is no internet connection. All the communication that the application does is through external servers, i.e. through internet. The application informs the user that the application is not functional and no alert trigger can be sent because there is no internet connection. When an ALERT SESSION is active the application gathers GPS data even if the user has NO internet connection. When the device gets back online the application will send all data to an external (online) storage.

The application keeps sending GPS location data to the real-time database as long as the application is in an ALERT SESSION.

Not Ready

As illustrated in FIG. 4, the application will default and display the NOT READY status setting if there is no access to some critical function of the device. The application requires permission to use the following functions of the device: the microphone, the camera, and the GPS locator. However, an ALERT SESSION can be started even if user has not granted access to microphone.

The operating system on mobile devices (e.g. iOS and Android) require that 3rd party apps request user permissions for certain features of the device to be used inside the application. The application requires permissions to operate the following functions of the device: access to microphone to detect the trigger for help, but also to record audio during an alert session, access to camera to record video during and alert session, access to accurate GPS location, the application sends this in real-time to emergency dispatcher.

The application does not verify if certain device functions are not working or malfunctioning. The application will not default to NOT READY if permissions are granted, but a certain function of the device is not working. The application offers TEST MODE to test the whole experience of the application by sending an alert to a test phone number instead of 911.

The application also requires the following minimum personal emergency data of the user to be present in the profile: photo, full name, birthday, gender, phone number, address, and at least one emergency contact. The application will also default to the NOT READY status setting if the minimum personal emergency data of the user is missing. Without any one of the above functions, permissions or lack of some personal emergency data, the application can be either limited in functionality or NON-functional at all under the NOT READY status setting. Limited functionality means that no audio will be sent to 911 dispatcher. Non-functional means that the ALERT SESSION cannot be started: if user does not grant permission to the application to access GPS location or the camera, if user is anonymous, or if user has not completed minimum personal emergency data.

The ALERT SESSION can be started even if user has not granted access to microphone.

Test Mode

In the TEST MODE status setting, the application is functional. The alert SMS goes to a user-predefined phone number instead of the emergency number (911 for US). This allows the user to understand the details on how the application operates before utilizing or subscribing to the service.

Also for the TEST MODE status setting, the user has to include the user-predefined phone number that the alert SMS will be sent to instead of the national emergency number. If the user-predefined phone number is not stored or is incomplete then the application will default to the NOT READY status setting. The application does not verify the user-predefined phone number. If the application sends an SMS to a no-working user-predefined phone number, the SMS sending service will respond with an error back to the application and the application explains the error to the user.

Predefined test number is ONLY for the TEST MODE, therefore is NOT critical functionality.

Test Mode (Manual Alert Only)

The TEST MODE status setting is described above with an alert being sent to the user-predetermined phone number instead of the national emergency number. In this state the application will send an SMS alert only if a manually entered alert is entered.

The MANUAL ALERT ONLY state denotes that the user has to press a button in the application to raise an alert. This state will raise the alert after a delay (10 seconds by default) to allow the user to cancel the action in case it's a mistake. The delay can be adjusted in settings or it can be completely disabled, i.e. the alert will be raised immediately after the button press.

The MANUAL ALERT ONLY state denotes that there is no access to the microphone and the application cannot be put in listening mode. Therefore any function that requires microphone will not be working, such as voice recording, voice streaming, and trigger recognition.

Ready (Manual Alert Only)

In READY (MANUAL ALERT ONLY), the application will send an SMS alert only if a manually entered alert is entered. The alert will be sent to the national emergency number. The MANUAL ALERT ONLY state denotes that there is no access to the microphone and the application cannot be put in listening mode. Therefore any function that requires microphone will not be working, such as voice recording, voice streaming, and trigger recognition.

Ready

In the READY status setting, the application is fully functional, i.e. the alert SMS will be sent to the national emergency number.

In additional aspects of the invention, the application includes an ALERT SESSION. In a further aspect of the invention, the user starts the ALERT SESSION, which will start the device's microphone and the application will begin to listen for specific alert triggers. The monitoring session starts when the user presses a specific button on the application.

In the TEST MODE, the user can familiarize and understand what the application does before starting the microphone and other features. There are some presets required before starting the ALERT SESSION. Presets that are required before starting the session include asking permission to use the microphone, camera and GPS location.

In additional aspects of the invention, a user can switch off the screen of the mobile device or use other apps while the application of the instant application listens for alert triggers in background.

The iPhone can send emergency call through Apple's Emergency SOS system. The application is independent from Apple's Emergency SOS. If the application is in listening mode, the application will keep listening for the alert trigger, such as “HELP HELP”, as long as the microphone is not in use by another application, such as a phone application. The Emergency SOS might be given higher priority by the operating system.

If the alert trigger has already occurred then the application will keep sending all data that it can gather maybe even audio data, depending if the Emergency SOS uses the microphone.

If the application is in background, such as on iPhone's lock screen or user switched to another app, then video streaming is impossible from the application which is a limitation by iPhone operating system iOS.

Alert Session

There are 2 ways in the application to start an ALERT SESSION: MANUAL ALERT or alert trigger. An ALERT SESSION will send an alert SMS, i.e. to raise an alert.

The MANUAL ALERT has been previously described in TEST MODE (MANUAL ALERT ONLY) and READY (MANUAL ALERT ONLY). The application can be put in listening mode, i.e. it will listen for “HELP” keyword. The application will meet the conditions of an alert trigger if user or anyone in the vicinity of the device says “HELP” twice during a short period of time. The application will switch to the ALERT SESSION automatically, even if the application is operating in background.

If the application is in ALERT SESSION then there is a different screen that the app will show and all the permissions are irrelevant—the application will try to gather whatever data it can gather and send it to dispatcher.

Speech Recognition

The application uses OpenEars speech recognition framework (PolitePix, available at www [.] politepix.com/openears) which is an offline speech recognition engine, i.e. it does all speech recognition directly on device and works also without internet connection. It is envisioned that other similar speech recognition frameworks could be utilized such as KeenResearch (available at keenresearch.com/).

In general, the speech recognition tools are probabilistic in their results, i.e. they have different levels of confidence in what was actually said. The offline speech recognition tools are typically less accurate than online tools like the ones from Apple, Google or Nuance (NUANCE, Nuance Communications, Inc., www [.] nuance.com, 1 Wayside Road, Burlington, Mass. 01803, USA). Also the offline tools could be configured to recognize a dictionary of words or sentences. It is also envisioned that the application can be trained to recognize just the user's voice as done by Nuance. The application is configured to recognize a single word—“HELP”.

Saying “Help! Help!” is different than screaming “Help! Help!” An elderly woman yelling “Help! Help” is different than a 12-year-old screaming “Help! Help!” As speech recognition tools become better at recognizing different versions, the app will be fine-tuned with the voice data from other end-users to help the software learn the different volumes, tones, timbre, and pitches of human voice resulting in a more robust application.

It is possible to get some false positives, i.e. to generate an alert trigger as a result when a different word (for example “HELICOPTER”) or group of words (for example “HELICOPTER HELPER”) were pronounced. It is possible to get some false positives, i.e. to generate an alert trigger as a result of listening to known phrases from media including the use of the word “HELP” closely followed by the word “HELP”, such as a popular phrase from the movie, Jerry McGuire: “Help me, Help you” or the popular song “Help!” by the Beatles. It is envisioned that known media phrases can be set a negative limitations as to not generate an alert trigger.

One way to mitigate dispatching emergency services for an alert trigger false positive is to send the audio associated with alert trigger to an online speech recognition service for confirmation. The application records segments of audio (about 15 seconds long) and sends the last audio segment to an online speech recognition service for confirmation with a more accurate speech recognizer. Currently the application uses Google Automatic Speech Recognition (more information is available at confluence.ict.usc.edu/pages/viewpage.action?pageId=17564684. It is envisioned that any other online speech recognition could be used for confirmation. The online speech recognizer tools are also NOT 100% accurate, therefore the application sends the last audio segment to the dispatcher for confirmation. Our aim is to provide the dispatcher with as much and as exact information to help make the correct decisions. The application will allow the dispatcher to listen to a predetermined audio segment before the alert was triggered.

When an alert is raised the application goes in ALERT SESSION and an ALERT SESSION record is created in a database. This alert session record is a special data container in the real-time database that holds information, such as: a unique identifier for the session, user information, GPS data in real-time, and any other session related data. The URL is created automatically, i.e. each alert session is assigned a unique identifier (ID) and the URL uses this ID.

The application creates a URL that will look like this: www [.] sayhelphelp.com/—Ksd9B5IrwW0wSCx5EnQ where the “—Ksd9B5IrwW0wSCx5EnQ” part is the session identifier. The URL together with an access code will be sent by SMS to 911. The full SMS text may be “Help requested—details at a hyper text transfer protocol like: www [.] sayhelphelp.com/—Ksd9B5IrwW0wSCx5EnQ—access code: 2505”. Further embodiments include additional text, data, and a reverse geocoded address, i.e. a postal address (street, region) obtained from GPS location.

The application uses a real-time database, Firebase, to store all session data. The app is the data-provider to this database and the web-page that dispatches sees is the consumer of this data.

When any new data is provided to the database then the consumer is notified to display or process the new data.

The application allows the dispatcher to switch the camera FRONT/BACK on user's device—in this case the web-page is the provider and the app is the consumer, i.e. it's a two-way communication between the web-page and the mobile app.

The user's profile and the session GPS data is also stored in real-time database with reference to the session ID. The audio and video streaming is done through a specialized service, Twilio, and is also referenced with session ID. It is envisioned that an access system will be created that will grant access to specific sessions to specific users. For example if a crime investigator needs access to a specific alert data, then the investigator can create an account and be assigned read-only access to the relevant information on that specific session.

About GPS

The application uses the most accurate and the most unrestricted GPS tools provided by the manufacturer of the mobile device. Smartphones including iPhone, are equipped with an integrated GPS antenna that can only locate the phone's whereabouts at a particular moment. GPS operates outside of the cellular signal, communicating directly with satellites to determine the phone's position. Data is not needed nor used for simply acquiring the phone's location by use of satellites.

GPS: A GPS antenna needs to make satellite connections and find the orbit and clock data before it knows its location. This is the ‘Time to First Fix (“TTFF”). The TTFF process can take from 30-seconds to a couple of minutes before a GPS antenna can acquire a signal—exactly how long depends on the surroundings and amount of interference. For example, GPS satellite signals may be impeded by tall buildings, and they do not penetrate building interiors well.

A-GPS: Smartphones, including iPhone, also have a feature called Assisted GPS (“A-GPS”), which helps the phone obtain a faster TTFF. A-GPS works by acquiring and storing information about the location of satellites using the cellular network, so the information does not need to be downloaded by satellite. A-GPS assists in acquiring the location of your iPhone using proximity to three cellular towers to help pinpoint your location faster when GPS signals are weak or not available. By itself, A-GPS does not position the mobile device as closely as GPS, but working together, the two cover all the bases. A-GPS requires a cellular data connection to acquire A-GPS data.

WPS: Smartphones, including iPhone, also have a Wi-Fi positioning system (WPS). WPS works the same way A-GPS works by assisting your device obtain a faster location information. Devices that have both GPS and Wi-Fi can be used to send information about a network back to a GPS company so that they can determine where the network is. A pop-up may appear suggesting turning Wi-Fi back on to improve location accuracy when Wi-Fi is turned off on a smartphone. WPS works by logging the GPS location of nearby devices to nearby Wi-Fi networks. Then, the next time someone is near one of those networks but does not have great GPS signal, WPS can be used to determine an approximate location since the Wi-Fi network's location is known.

Without a GPS signal, A-GPS is used to triangulate the phone's location. This triangulation method is currently used to make the phone's location available to emergency call dispatchers and is only accurate within an area of about ¾ square mile.

Without a GPS signal, WPS can be used to triangulate the phone's location within 15 to 50 feet, depending on the preconditions. One advantage to WPS over GPS is that WPS can sometimes make it is possible to determine the current floor level if the phone is in a building.

Without A-GPS or WPS, it may take anywhere from 30-seconds to a couple of minutes before the GPS antenna can acquire a GPS signal, if a GPS signal can be acquired at all. Without GPS, A-GPS, or WPS, the phone's location cannot be detected.

Dispatcher's Experience

The dispatcher receives an SMS like below:

“SAY HELP! An automated emergency message has been triggered. JOHN SMITH needs emergency help at the following address: 7104 VILLAGE OAKS DR, AVON, Ind. 46123, USA. Go to https://sayhelp.com/—LGID2G9fD8zqIBVhPQS for updated real-time information.”

When the dispatcher clicks the link in the SMS, the dispatcher's web browser is taken to a web-page. The URL will work in any browser, the 911 dispatcher can receive the URL on a computer and may click to open it in a browser. The web page that the URL opens will present the user information together with a geographical map with real-time location of the phone. The URL will also show a reverse geocoded address so that the dispatcher can communicate easily the street name and number to police or any other services.

The web page will also include a button to start a VOIP call with the phone that sent the SMS text. The VOIP may be directly in browser.

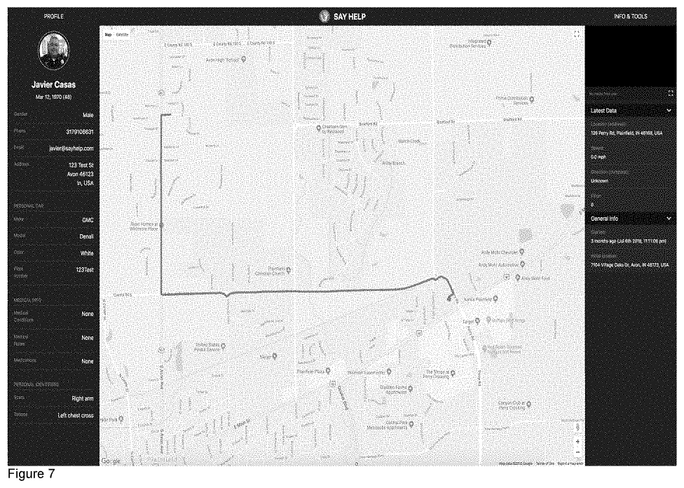

The webpage will display the following information as illustrated in FIG. 7: the user's profile information, a map with accurate location of the device where the location is updated in real-time, and information and tools.

The information and tools include audio and video stream from the device, readable address, speed and direction of movement and also floor (when detected) of the latest location of the device, general info about the alert session, like the exact time and location when the alert was started. The dispatcher can switch between back and front camera when video stream is available. Also there is an option for the dispatcher to say something to the user on device's speaker phone. All media (audio and video) is recorded on external servers and kept on record for a non-determined time.

Additional data will be included here, like how the alert was triggered (MANUALLY or from LISTENING MODE), also access to the audio recording that triggered the alert in case the application was started from a listening mode.

It is envisioned to add an option to allow the dispatcher to resend the alert to another number, maybe to a different dispatcher, maybe in a different area.

The speech recognition is performed online, currently using Google ASR, or on-device through a 3rd party service, currently OpenEars.

The session can be deactivated from inside the application by the user by pressing a stop alert button. When the session becomes inactive—no more location data is added to the record and the web application will not receive any new data.

All data for all alert sessions for all users will be stored on a server permanently or for a reasonable amount of time, and can be made available to authorities on demand.

In another aspect of the invention, the web page permits access to users' alert sessions through a special URL+an access code. Both the URL and the access code are sent in SMS when an alert is triggered on device.

In additional aspects of the invention, the web application can set specific data in real-time database to request additional information or additional actions from user's device (e.g. start an alarm sound on user's device, instruct user's device to initiate audio and/or video call to a specific number with options to choose one-way audio and/or front/back camera, speaker volume, etc.)

If the user is speaking with the dispatcher on the phone then the phone application on the device is the active application and therefore the phone application has undivided access to the microphone, therefore there is currently no audio recording in the application. When the microphone is not used by another application then the application commanders the microphone and starts recording and streaming the audio in real-time to the dispatcher, even if the application is active in background.

About the pictures and video recorded from the camera, third party applications on mobile devices can use the camera only while the application is active in foreground, i.e. if the application operates in background then there is no access to camera. When the application gets in foreground then the camera access is restored and the application will start recording video and streaming it in real-time to the dispatcher.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

What is claimed is:

1. A mobile device application for handling urgent situations or hazardous situations wherein the app:
(a) monitoring speech for alert trigger occurring around the mobile device,
(b) configured to send a text message with an URL to either a user defined emergency number or a national emergency number,
(c) wherein the URL leads to a web page that provides real-time location data of the mobile device.

2. The mobile device application of claim 1 wherein the step of monitoring speech is conducted in background on the mobile device.

3. The mobile device application of claim 1 wherein the step of monitoring speech means the application is in a listening mode, wherein the application will listen for the word “HELP”.

4. The mobile device application of claim 1 wherein the alert trigger occurs user or anyone in the vicinity of the mobile device says “HELP” twice during a predetermined period of time.

5. The mobile device application of claim 1 wherein the alert trigger causes the application will switch to an ALERT SESSION automatically, even if the application is operating in background, wherein the alert session causes the application to send a text message with an URL to either a user defined emergency number or a national emergency number.

6. The mobile device application of claim 1 wherein the alert trigger causes the application send the last segment of audio associated with the alert trigger to an online speech recognition service or the dispatcher for confirmation, wherein the segment of audio is approximately 15 seconds long.

7. The mobile device application of claim 1 wherein the ALERT SESSION means that an alert session record is created in a database, wherein the alert session record is a special data container in the real-time database that holds information, including a unique identifier for the session, user information, GPS data in real-time, and any other session related data, wherein the URL is created automatically, wherein each alert session is assigned a unique identifier and the URL uses the unique identifier.

8. The mobile device application of claim 1 wherein the application allows a dispatcher to switch between the front and back cameras on the user's mobile device.

9. The mobile device application of claim 1 wherein the application uses the GPS tools provided by the manufacturer of the mobile device including an integrated GPS antenna, wherein the GPS tools include GPS, Assisted GPS, and Wi-Fi positioning system.

10. The mobile device application of claim 1 wherein the web page provides additional information from data collected by the mobile device.

11. The mobile device application of claim 10 wherein the additional information is provided on request of a dispatcher or by default.

12. The mobile device application of claim 1 wherein the application continually uploads real-time data to the web page as long as the application is in alert mode.

13. The mobile device application of claim 1 wherein the application includes the following status settings: NO INTERNET, NOT READY, TEST MODE, TEST MODE (MANUAL ALERT ONLY), MANUAL ALERT ONLY, or READY,
wherein the status setting NO INTERNET means the application is not functional except if ALERT SESSION is active the application stores GPS data on the mobile device and the application sends all data when the mobile device regains internet connectivity,
wherein the status setting NOT READY means the application does not have permission to access a critical function of the mobile device, wherein the critical function is the camera or the GPS locator,
wherein the status setting TEST MODE means the application is functional, wherein the alert can be triggered in listening mode or by a manually entered alert, but the alert SMS goes to a user-predefined phone number instead of the national emergency number, wherein if the user-predefined phone number is not stored or is incomplete then the application will default to the NOT READY status setting,
wherein the status setting TEST MODE (MANUAL ALERT ONLY) means the application will send an SMS alert only if a manually entered alert is entered by the user pressing a button in the application to raise an alert, wherein the application will raise the alert after a predetermined 10 second delay, a user defined delay or without delay to allow the user to cancel the action in case of mistake,
wherein the status setting READY (MANUAL ALERT ONLY) means the application will send an SMS alert to the national emergency number only if a manually entered alert is entered, and
wherein the status setting READY means the application is fully functional wherein the alert can be triggered in listening mode or by a manually entered alert, and the alert SMS will be sent to the national emergency number.
